(19) United States
(12) Patent Application Publication
(10) Pub. No.: US 2014/0318675 A1
(43) Pub. Date: Oct. 30, 2014

(54) PNEUMATIC TIRE USED IN MOTORCYCLE CROSS-COUNTRY RACE

(71) Applicant: CHENG SHIN RUBBER (XIAMEN) IND., LTD., Xiamen, Fujian (CN)

(72) Inventor: Shiu-Hsiung Chen, Xiamen (CN)

(73) Assignee: CHENG SHIN RUBBER (XIAMEN) IND., LTD., Xiamen, Fujian (CN)

(21) Appl. No.: 14/361,898

(22) PCT Filed: Oct. 10, 2012
(86) PCT No.: PCT/CN2012/082689

§ 371 Date: May 30, 2014

(30) Foreign Application Priority Data
Sep. 28, 2012 (CN) 201220506094.6

(51) Int. Cl. B60C 11/11; B60C 11/03

(52) U.S. Cl. CPC B60C 11/11; B60C 11/033
USPC 152/209.11

(57) ABSTRACT

A pneumatic tire includes a tire crown area, central area and tire shoulder area on the tire tread, and tire crown pattern blocks, central pattern blocks and tire shoulder pattern blocks disposed in corresponding area of the tire tread, wherein in a pattern pitch of the tire tread, the tire crown pattern blocks comprising big tire crown pattern blocks and small tire crown pattern blocks in equal numbers, they are spaced arranged; the central pattern blocks are symmetrically arranged in two sides of the tire crown pattern blocks, the central pattern blocks in either side are alternately arranged with respect to the tire crown pattern blocks longitudinally, the central pattern blocks in either side are alternately arranged left and right with transverse space laterally; the tire shoulder pattern blocks are symmetrically arranged in two sides of the both sides of the central pattern blocks.

### FIELD OF THE INVENTION

The present invention relates to a pneumatic tire used in motorcycle cross-country race.

### BACKGROUND OF THE INVENTION

In existing technology, the tire tread pattern of the pneumatic tire used in motorcycle cross-country race is applied with regular pattern blocks, to ensure impelling power and disposal performance on rough road surface, the pattern blocks are spaced arranged, thereinto, for a tire used in cross-country race on hard road surface, as figured in FIG. 1, to enhance the tractive ability and the turn performance when running straight on a hard land, the total land ratio of the pattern (the total superficial area of all pattern blocks on the tire tread to the total area of the tire tread) is set higher, the land ratio of the tire tread pattern is set that the land ratio of the central area B>the land ratio of the tire crown area A>the land ratio of the tire shoulder area C (the total superficial area of the pattern blocks of this area to the total area of this area), the pattern blocks are set with equal height, for a tire used in cross-country race on soft land surface, as figured in FIG. 2, to ensure that the pattern block is easy to sink into soil and to provide high tractive ability and turn performance, the pattern land ratio of the pattern is set lower, the land ratio of the pattern block is set that the land ratio of the tire crown area A>the land ratio of the central area B>the land ratio of the tire shoulder area C. However, for hard-middle land surface, the cross-country race tire is used to contest and jump run, existing tire pattern is just applied in single land, it's hard to mix both high straight tractive ability and turn performance on hard-middle land surface to contest and jump run.

### SUMMARY OF THE INVENTION

To solve above disadvantage that the existing motorcycle cross-country race is hard to mix both high straight tractive ability and turn performance on hard-middle land surface, the present invention is provided with a pneumatic tire used in motorcycle cross-country race, the technical proposal of the present invention is as below:

A pneumatic tire used in motorcycle cross-country race, comprising tire crown area, central area and tire shoulder area on the tire tread, and tire crown pattern blocks, central pattern blocks and tire shoulder pattern blocks disposed in corresponding area of the tire tread, wherein in a pattern pitch of the tire tread, the tire crown pattern blocks comprising big tire crown pattern blocks and small tire crown pattern blocks in equal numbers and spaced arranged; the central pattern blocks are symmetrically arranged in two sides of the tire crown pattern blocks, the central pattern blocks in either side are alternately arranged with respect to the tire crown pattern blocks longitudinally, the central pattern blocks in either side are alternately arranged left and right with transverse space laterally; the tire shoulder pattern blocks are symmetrically arranged in two sides of the both sides of the central pattern blocks, the number of either side of the tire shoulder pattern blocks is more than that of either side of central pattern blocks and the tire crown pattern blocks; the land ratio of the central area is smaller than that of the tire crown area and the tire shoulder area; the height of the tire shoulder pattern block is higher that of the tire crown pattern block and that of the central pattern block. In another preferred embodiment, the length of the big tire crown pattern block is ¼-⅓ of the total width of the tire tread, the length of the small tire crown pattern block is ⅔-¾ of the length of the big tire crown pattern block.

In another preferred embodiment, the transverse space of two adjacent central pattern blocks is ⅓-⅔ of the length of the central pattern block. In another preferred embodiment, the land ratio of the tire crown area is 20%-25%, the land ratio of the central area is 15%-20%, the land ratio of the tire shoulder area is 25%-30%.

In another preferred embodiment, the height of the tire crown pattern block, the central pattern block or the tire shoulder pattern block is 10-25 mm; the difference in height of the tire shoulder pattern block from the tire crown pattern block or the central pattern block is 1-4 mm.

In another preferred embodiment, the top surface of the tire crown pattern block and the central pattern block is disposed with shallow grooves and/or small grooves, the number of the tire crown pattern blocks and the central pattern blocks in a pattern pitch is 2-8.

In another preferred embodiment, the side surface of the central pattern block is disposed with irregular surface, the irregular surface is faced to the lateral external side of the tire tread, the irregular surfaces of two adjacent central pattern blocks are opposite to each other along the longitudinal direction of the tire tread.

In another preferred embodiment, the small tire crown pattern block and the central pattern block are disposed with reinforcing ribs therebetween, the reinforcing ribs are symmetrically arranged left and right in the longitudinal direction of the tire tread, the reinforcing rib inclines with respect to the traveling direction of the tire, the thickness of the reinforcing rib is 2-9 mm.

In another preferred embodiment, the depth of the shallow groove or the small groove is 2-9 mm, the width is 2-5 mm.

In another preferred embodiment, in a pattern pitch, the big tire crown pattern blocks have single shape or with different shapes.

The advantages of the technical proposal of the present invention are that:

1. with the arrangement of the pattern blocks of each area on the tire tread and proper designation of the land ratio, the central pattern blocks contact the land with small area, while the tire crown pattern blocks and the tire shoulder pattern blocks contact the land with large enough area, which ensures stability when the motorcycle is straight running, and when turning a corner, it disposes the soil quickly, thus promoting tractive ability and turn a corner effectively.

2. the irregular surfaces of two adjacent central pattern blocks are opposite to each other along the longitudinal direction of the tire tread, thus promoting the tractive ability and soil disposal performance when the straight running motorcycle changes to turn a corner, so that the motorcycle turns a corner effectively.

### BRIEF DESCRIPTION OF THE DRAWINGS

The present invention will be further described with the drawings and the embodiments.

FIG. 1 illustrates a plan sketch of an existing tire tread 1 used in motorcycle cross-country race.

FIG. 2 illustrates a plan sketch of another existing tire tread 1 used in motorcycle cross-country race.

FIG. 3 illustrates a plan sketch of a tire tread 1 of a first embodiment of the present invention.

FIG. 4 illustrates a sectional view of a section AA′ of a big tire crown pattern block 11 of the first embodiment in FIG. 3.

FIG. 5 illustrates a sectional view of another section BB′ of a big tire crown pattern block 11 of the first embodiment in FIG. 3.

FIG. 6 illustrates a sectional view of a section CC′ of a central pattern block 20 of the first embodiment of FIG. 3.

FIG. 7 illustrates a sectional view of a section DD′ of a reinforcing rib 40 of the first embodiment of the FIG. 3.

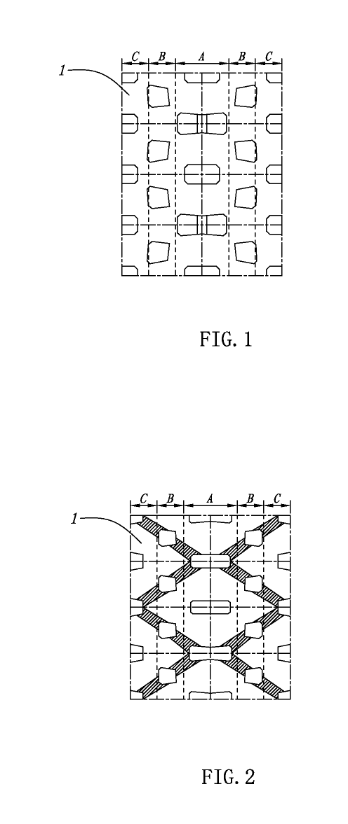

### DETAILED DESCRIPTION OF THE EMBODIMENTS

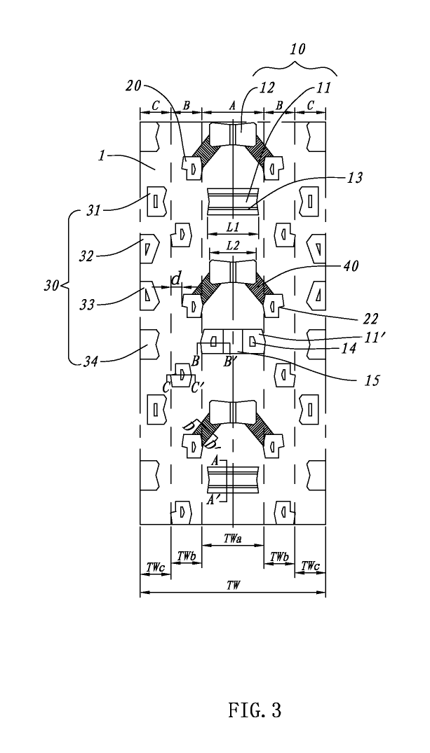

As figured in FIG. 3 to FIG. 7, disclosed are sectional diagrams and partial sectional diagrams of the tire tread of the embodiment of the present invention.

A pneumatic tire used in motorcycle cross-country race comprising a tire crown area A, a central area B and a tire shoulder area C on the tire tread 1, the width TWa, TWb, TWc of each area are respectively set to ⅓ of the total width TW of the tire tread, and corresponding tire crown pattern blocks 10, central pattern blocks 20 and tire shoulder pattern blocks 30 on each area of the tire tread 1; the tire shoulder pattern block 30 comprising a first pattern blocks 31, a second pattern blocks 32, a third pattern blocks 33 and a fourth pattern blocks 34, the land ratio of the central area B is lower than that of the tire crown area A, and is lower than that of the tire shoulder area C as well; in this embodiment, the land ratio of the central area B is 15%-20%, the land ratio of the tire crown area A is 20-25%, the land ratio of the tire shoulder area C is 25%-30%; besides, the height of the tire shoulder pattern block 30 is higher than that of the tire crown pattern block 10 and that of the central pattern block 20, the heights of the tire crown pattern block, the central pattern block and the tire shoulder pattern block range from 10 mm to 25 mm; the differences in height of the tire shoulder pattern block and the tire crown pattern block or the central pattern block range from 1 mm to 4 mm. In this way, when the pneumatic tire used in motorcycle cross-country race jumps and runs on hard-middle land surface, the central pattern blocks 20 contact the land with small area, while the tire crown pattern blocks 10 and the tire shoulder pattern blocks 30 contact the land with large enough area, which ensures straight tractive ability and stability, furthermore, when turning a corner during straight running, the tire can clear away the soil quickly, thus promoting the tractive ability, and then turn a corner effectively.

In this embodiment, the tire tread 1 is divided into several same pattern pitches (1 Pitch), the pattern blocks of each pattern pitch are of correspondingly same shape and arrangement and repeat on the whole tire tread. FIG. 3 illustrates a section of a whole pattern pitch of the tire tread 1.

The tire crown pattern block 10 comprising big tire crown pattern blocks 11 and small tire crown pattern blocks 12 in equal numbers, they are spaced arranged, the number of the tire crown pattern blocks 10 in a pattern pitch is 2-8; the length L1 of the big tire crown pattern block 11 is ¼-⅓ of the total width TW of the tire tread, the length L2 of the small tire crown pattern block 12 is ⅔-¾ of the length L1 of the big tire crown pattern block 11. In this way, the big and small pattern blocks have enough irregular widths, thus having well grip performance, in actual design, two ends of both big tire crown pattern blocks 11 and small tire crown pattern blocks 12 can be respectively designed with very irregular shape to enhance the edge effect thus to promote tractive ability.

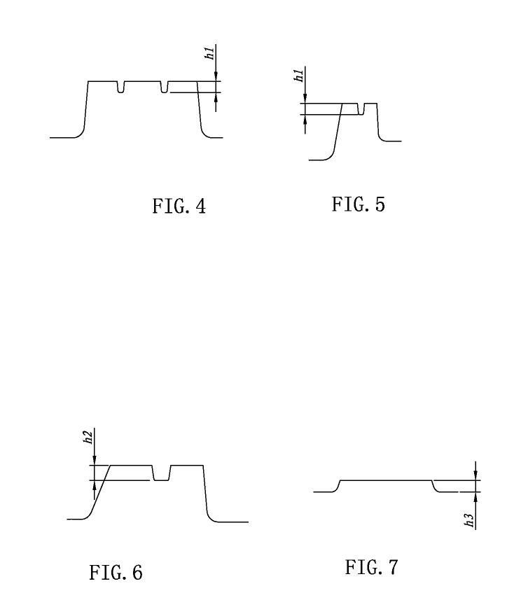

In a same pattern pitch, the big tire crown pattern blocks can be big tire crown pattern blocks 11 of single shape or big tire crown pattern blocks 11 and big tire crown pattern blocks 11′ of different shape. The big tire crown pattern block 11 have two lateral small groove 13 (as figured in FIG. 4); the left and right of the big tire crown pattern block 11′ are respectively disposed with one small groove 14, the central is disposed with a shallow groove 15 longitudinally (as figured in FIG. 5).

In the same pattern pitch, the central pattern blocks 20 are symmetrically arranged in two sides of the tire crown pattern blocks 10, that is to say, in the central area B, the central pattern blocks 20 in either side are alternately arranged with respect to the tire crown pattern blocks 10 longitudinally; the central pattern blocks 20 in either side are alternately arranged left and right with transverse space laterally, besides, the central pattern blocks 20 in either side are alternately arranged left and right with transverse space d laterally; the transverse space of two adjacent central pattern blocks is ⅓-⅔ of the length of the central pattern block 20. The number of each side of central pattern blocks 20 in a pattern pitch is 2-8, thus making the central pattern blocks 20 arranged jagged in the longitudinal direction of the tire tread 1, this shape of the central pattern blocks 20 have well grip performance when turning a corner, the alternately arrangement of the central pattern blocks 20 and the tire crown pattern blocks 10 makes it with well soil disposal ability. Preferred, the side surface of the central pattern blocks 20 is disposed with irregular surface 22, which is faced to the lateral external side of the tire tread 1, and the irregular surfaces of two adjacent central pattern blocks 20 are opposite to each other along the longitudinal direction of the tire tread 1, thus promoting the tractive ability and soil disposal performance when the straight running motorcycle changes to turn a corner, and promoting the stability of the tire, thus making the motorcycle turning a corner effectively.

In this pattern pitch, the tire shoulder pattern blocks 30 are symmetrically arranged in two sides of both two sides of central pattern blocks 20, that is to say, the tire shoulder area C, either side of the tire shoulder patter blocks 30 has more amount than that of the either side of central pattern blocks 10 and tire crown pattern blocks 20, they arranges unequally in the longitudinal direction of the tire tread 1, thus making the tire shoulder area C still with well antiskid performance and tractive ability when turning a corner to a great extent.

The small tire crown pattern blocks 12 and the central pattern blocks 20 have reinforcing ribs 40 therebetween, the reinforcing ribs are symmetrically arranged left and right in the longitudinal direction of the tire tread 1, and the reinforcing ribs inclines with respect to the traveling direction of the tire, in FIG. 7 of a sectional view of section DD′ of the reinforcing rib 40, the thickness h3 thereof is 2-9 mm, the reinforcing ribs thus enhance the rigidity of the small tire crown pattern blocks 12, thus keeping the shape of the tire tread when disposing the soil.

In all pattern blocks, whether the tire crown pattern blocks 10, the central pattern blocks 20 or the tire shoulder pattern blocks 30, they have shallow grooves 13 and small groove 14; the shallower grooves 13 can improve the soil disposal effect, while the small groove 14 can improve the cooling effect and deforming and grip land ability; to ensure well tractive ability and turn performance, FIG. 4 is a sectional view of a section AA′ of a big tire crown pattern block 11, the depth of the shallow groove h1 is 2-9 mm, a section BB′ of a big tire crown pattern blocks 11′ in FIG. 5 is a small groove, the depth h1 is 2-9 mm; in FIG. 6, a sectional view of a section CC′ of a central pattern block 20, the depth h2 of the small groove is 2-9 mm; the width of the shallow grooves and the small grooves can be change according to different pattern blocks in different size, usually, the width is set to 2-5 mm.

In this way, the pneumatic tire used in motorcycle cross-country race can mix both high straight tractive ability and turn performance on hard-middle land surface to contest, jump and run.

Applied with the technical proposal of the present invention, choosing specification of 110/90-19 62M TT to the traveling wheel of the cross-country motorcycle, setting the test tires of previous embodiment of existing technology, the first embodiment and the second embodiment of the present invention to tire rims of 2.50×19, and blowing to 91 kPa internal pressure, then assembling the wheels respetively to a motorcycle with discharging rate 450 CC, the motorcycle type is KX205F, covering one layer of soft soil to the hard land surface, the motorcycle contested and jumped and run on the mix land surface, evaluating the straight tractive ability and turn performance and stability when turning a corner, according to the drivers' sensory evaluation, taking the index of the previous embodiment to be 100, larger the value is, better the performance is. The test results are figured out in table 1.

TABLE 1

| | Previous | The first | The second |
|---|---|---|---|
| | embodiment | embodiment | embodiment |
| Width of the tire crown | ⅓ * TW | ⅓ * TW | ⅓ * TW |
| area TWa (mm) | | | |
| Width of the central area | ⅓ * TW | ⅓ * TW | ⅓ * TW |
| TWb (mm) | | | |
| Width of the tire | ⅓ * TW | ⅓ * TW | ⅓ * TW |
| shoulder area TWc (mm) | | | |
| Number of pattern | 4 | 6 | 2 |
| blocks in the tire crown | | | |
| area in 1 Pitch | | | |
| Size of the pattern blocks | equal | unequal | unequal |
| of the tire crown area | | | |
| Length L2 of the big | ¼ * TW | ⅓ * TW | ⅓ * TW |
| pattern blocks of the tire | | | |
| crown area (mm) | | | |
| Length L1 of the small | L2 | ¾L2 | ⅔L2 |
| pattern blocks of the tire | | | |
| crown area (mm) | | | |
| Are there small grooves | NO | YES | YES |
| or shallow groove in the | | | |
| pattern blocks of the tire | | | |
| crown area? | | | |
| Width of the small | — | 4 | 10 |
| grooves or shallow | | | |
| grooves (mm) | | | |
| Depth h1 of the small | — | 3 | 11 |
| grooves or shallow | | | |
| grooves (mm) | | | |
| Land ratio of the tire | 23% | 25% | 27% |
| crown area | | | |
| Number of pattern | 4 | 6 | 4 |
| blocks in the central area | | | |
| in 1 Pitch | | | |
| Are the pattern blocks in | NO | YES | NO |
| the central area | | | |
| alternately arranged? | | | |
| Are there small grooves | NO | YES | NO |
| or shallow groove in the | | | |
| pattern blocks of the | | | |
| central area? | | | |
| Does the side surface of | NO | YES | NO |
| the pattern block of the | | | |
| central area have | | | |
| irregular surface? | | | |
| Width of the small | — | 3 | — |
| grooves or shallow | | | |
| grooves (mm) | | | |
| Depth h2 of the small | — | 4 | — |
| grooves or shallow | | | |
| grooves (mm) | | | |
| The land ratio of the | 21% | 19% | 29% |
| central area | | | |
| Are there reinforcing ribs | YES | YES | NO |
| disposed between the tire | | | |
| crown area and the | | | |
| central area? | | | |
| Height h3 of the | 3 | 4 | — |
| reinforcing ribs (mm) | | | |
| Number of the pattern | 4 | 7 | 4 |
| blocks in the tire | | | |
| shoulder area in 1 Pitch | | | |
| Different in height of the | 0 | 2.5 | 0 |
| tire shoulder pattern | | | |
| blocks and the central | | | |
| pattern blocks | | | |
| Land ratio of the tire | 16% | 28% | 22% |
| shoulder area | | | |
| straight tractive ability | 100 | 105 | 105 |
| (index) | | | |
| Turn performance | 100 | 110 | 100 |
| (index) | | | |
| Stability when turning a | 100 | 105 | 105 |
| corner (index) | | | |

From above, the straight tractive ability, turn performance and stability when turning a corner of the embodiments of the present invention are better than that of the previous embodiment, a pneumatic tire used in motorcycle cross-country race of the present invention has high straight tractive ability and turn performance on hard-middle land surface when contesting or jump running.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

### INDUSTRIAL APPLICABILITY

The present invention is provided with a pneumatic tire used in motorcycle cross-country race, with the arrangement of the pattern blocks of each area on the tire tread and proper designation of the land ratio, the central pattern blocks contact the land with small area, while the tire crown pattern blocks and the tire shoulder pattern blocks contact the land with large enough area, which ensures stability when the motorcycle is straight running, and when turning a corner, it disposes the soil quickly, thus promoting tractive ability and turn a corner effectively. The present invention is designed professionally and produced conveniently with well industrial applicability.

1. A pneumatic tire used in motorcycle cross-country race, comprising tire crown area, central area and tire shoulder area on the tire tread, and tire crown pattern blocks, central pattern blocks and tire shoulder pattern blocks disposed in corresponding area of the tire tread, wherein in a pattern pitch of the tire tread, the tire crown pattern blocks comprising big tire crown pattern blocks and small tire crown pattern blocks in equal numbers and spaced arranged; the central pattern blocks are symmetrically arranged in two sides of the tire crown pattern blocks, the central pattern blocks in either side are alternately arranged with respect to the tire crown pattern blocks longitudinally, the central pattern blocks in either side are alternately arranged left and right with transverse space laterally; the tire shoulder pattern blocks are symmetrically arranged in two sides of the both sides of the central pattern blocks, the number of either side of the tire shoulder pattern blocks is more than that of either side of central pattern blocks and the tire crown pattern blocks; the land ratio of the central area is smaller than that of the tire crown area and the tire shoulder area; the height of the tire shoulder pattern block is higher that of the tire crown pattern block and that of the central pattern block.

2. The pneumatic tire used in motorcycle cross-country race according to claim 1, wherein the length of the big tire crown pattern block is ¼-⅓ of the total width of the tire tread, the length of the small tire crown pattern block is ⅔-¾ of the length of the big tire crown pattern block.

3. The pneumatic tire used in motorcycle cross-country race according to claim 1, wherein the transverse space of two adjacent central pattern blocks is ⅓-⅔ of the length of the central pattern block.

4. The pneumatic tire used in motorcycle cross-country race according to claim 1, wherein the land ratio of the tire crown area is 20%-25%, the land ratio of the central area is 15%-20%, the land ratio of the tire shoulder area is 25%-30%.

5. The pneumatic tire used in motorcycle cross-country race according to claim 1, wherein the height of the tire crown pattern block, the central pattern block or the tire shoulder pattern block is 10-25 mm; the difference in height of the tire shoulder pattern block from the tire crown pattern block or the central pattern block is 1-4 mm.

6. The pneumatic tire used in motorcycle cross-country race according to claim, wherein the top surface of the tire crown pattern block and the central pattern block is disposed with shallow grooves and/or small grooves, the number of the tire crown pattern blocks and the central pattern blocks in a pattern pitch is 2-8.

7. The pneumatic tire used in motorcycle cross-country race according to claim 3, wherein the side surface of the central pattern block is disposed with irregular surface, the irregular surface is faced to the lateral external side of the tire tread, the irregular surfaces of two adjacent central pattern blocks are opposite to each other along the longitudinal direction of the tire tread.

8. The pneumatic tire used in motorcycle cross-country race according to claim 6, wherein the small tire crown pattern block and the central pattern block are disposed with reinforcing ribs therebetween, the reinforcing ribs are symmetrically arranged left and right in the longitudinal direction of the tire tread, the reinforcing rib inclines with respect to the traveling direction of the tire, the thickness of the reinforcing rib is 2-9 mm.

9. The pneumatic tire used in motorcycle cross-country race according to claim 6, wherein the depth of the shallow groove or the small groove is 2-9 mm, the width is 2-5 mm.

10. The pneumatic tire used in motorcycle cross-country race according to claim 6, wherein in a pattern pitch, the big tire crown pattern blocks have single shape or with different shapes.

11. The pneumatic tire used in motorcycle cross-country race according to claim 2 or claim 3, wherein the top surface of the tire crown pattern block and the central pattern block is disposed with shallow grooves and/or small groves, the number is the tire crown pattern blocks and the central pattern blocks in a pattern pitch is 2-8.

12. The pneumatic tire used in motorcycle cross-country race according to claim 11, wherein the small crown pattern block and the central pattern block are disposed with reinforcing ribs therebetween, the reinforcing ribs are symmetrically arranged left and right in the longitudinal direction of the tire tread, the reinforcing rib inclines with respect to the traveling direction of the tire, the thickness of the reinforcing rib is 2-9 mm.

13. The pneumatic tire used in motorcycle cross-country race according to claim 11, wherein the depth of the shallow grove or the small groove is 2-9 mm, the width is 2-5 mm.

14. The pneumatic tire used in motorcycle cross-country race according to claim 11, wherein in a pattern pitch, the big tire crown pattern blocks have single shape or with different shapes.
